(19) United States
(12) Patent Application Publication
(10) Pub. No.: US 2024/0323236 A1
(43) Pub. Date: Sep. 26, 2024

(54) RECORDING SELECTIVE METAVERSE COLLABORATION CONTENT

(71) Applicant: International Business Machines Corporation, Armonk, NY (US)

(72) Inventors: Jill S. Dhillon, Jupiter, FL (US); Jeremy R. Fox, Georgetown, TX (US); Tushar Agrawal, West Fargo, ND (US); Sarbajit K. Rakshit, Kolkata (IN)

(21) Appl. No.: 18/123,419

(22) Filed: Mar. 20, 2023

(51) Int. Cl. H04L 65/1066; G06Q 10/101

(52) U.S. Cl. CPC H04L 65/1066; G06Q 10/101

(57) ABSTRACT

A computer-implemented method, system and computer program product for selectively recording metaverse collaboration content. Contextual boundaries to perform selective recording in a collaborative environment of a metaverse are received from a user. Contextual boundaries refer to designations in the collaborative environment, including participants and collaboration content being shared, based on the context of the collaborative environment. In addition to receiving contextual boundaries, a workflow sequence, which defines portions of the contextual boundaries to record, is received from the user. A workflow sequence refers to the order of the selective recording in the collaborative environment of the metaverse. Metaverse collaboration content in the collaborative environment is then recorded using a recording node sequence based on the workflow sequence. A second collaborative environment of the metaverse may then be created based on the recorded metaverse collaboration content. In this manner, user-designated metaverse collaboration content in the metaverse may be selectively recorded.

### TECHNICAL FIELD

The present disclosure relates generally to the metaverse, and more particularly to selectively recording metaverse collaboration content.

### BACKGROUND

The term “metaverse” refers to any digital or virtual reality platform that combines any combination of aspects from online gaming, social media, virtual reality, augmented reality, cryptocurrencies or non-fungible tokens (NFTs) for users to interact with one another. The term “metaverse” originated in the 1992 science fiction novel Snow Crash as a portmanteau of “meta” and “universe.” Metaverse development is often linked to advancing virtual reality technology due to the increasing demands for immersion. Recent interest in metaverse development is influenced by Web3, a concept for a decentralized iteration of the Internet. However, metaverse worlds are not necessarily a uniquely Web3 aspect. For example, the online gaming platform Roblox is considered to be a metaverse world, though it does not use cryptocurrency, NFTs, or blockchain technology on the platform. In contrast, the virtual world Decentraland is an entirely Web3-based platform that utilizes NFTs, cryptocurrencies, decentralized storage and blockchain networks on the backend.

### SUMMARY

In one embodiment of the present disclosure, a computer-implemented method for selectively recording metaverse collaboration content comprises receiving contextual boundaries to perform selective recording in a first collaborative environment of a metaverse. The method further comprises receiving a workflow sequence which defines portions of the contextual boundaries to record via one or more nodes. The method additionally comprises recording metaverse collaboration content in the first collaborative environment of the metaverse using a recording node sequence based on the workflow sequence. Furthermore, the method comprises creating a second collaborative environment of the metaverse based on the recorded metaverse collaboration content.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates an embodiment of the hardware configuration of the computing device which is representative of a hardware environment for practicing the present disclosure;

FIG. 3 illustrates an embodiment of the hardware configuration of the metaverse server which is representative of a hardware environment for practicing the present disclosure;

FIG. 4 is a diagram of the software components used by the metaverse collaboration content recording mechanism to selectively record metaverse collaboration content in accordance with an embodiment of the present disclosure;

FIG. 5 illustrates creating collaborative environments in the metaverse in accordance with an embodiment of the present disclosure;

FIG. 6 illustrates an embodiment of the present disclosure of the hardware configuration of the metaverse collaboration content recording mechanism which is representative of a hardware environment for practicing the present disclosure;

FIG. 7 is a flowchart of a method for selectively recording metaverse collaboration content in accordance with an embodiment of the present disclosure;

FIG. 8 is a flowchart of a method for generating the recording node sequence in accordance with an embodiment of the present disclosure; and

FIG. 9 is a flowchart of a method for creating a third collaborative environment of the metaverse in response to authorized users joining the second collaborative environment of the metaverse created based on the recorded metaverse collaboration content in accordance with an embodiment of the present disclosure.

### DETAILED DESCRIPTION

As stated above, the term “metaverse” refers to any digital or virtual reality platform that combines any combination of aspects from online gaming, social media, virtual reality, augmented reality, cryptocurrencies or non-fungible tokens (NFTs) for users to interact with one another. The term “metaverse” originated in the 1992 science fiction novel Snow Crash as a portmanteau of “meta” and “universe.” Metaverse development is often linked to advancing virtual reality technology due to the increasing demands for immersion. Recent interest in metaverse development is influenced by Web3, a concept for a decentralized iteration of the Internet. However, metaverse worlds are not necessarily a uniquely Web3 aspect. For example, the online gaming platform Roblox is considered to be a metaverse world, though it does not use cryptocurrency, NFTs, or blockchain technology on the platform. In contrast, the virtual world Decentraland is an entirely Web3-based platform that utilizes NFTs, cryptocurrencies, decentralized storage and blockchain networks on the backend.

An example of a metaverse environment consists of a mixed reality meeting where the users are wearing virtual reality headsets in their virtual offices. After finishing the meeting, a user may relax by playing a blockchain-based game and then managing a crypto portfolio while inside the metaverse.

While attending a metaverse collaboration (group of users interacting in the metaverse), a user may want to selectively and autonomously record the metaverse collaboration content. For example, while attending a metaverse collaboration, such as a learning session, where a presenter is sharing digital presentation contents to students, a user may want to selectively record the presentation content, the presentation content along with the presenter (as an avatar) or the entire metaverse collaboration (the avatars of the presenter and students along with the presentation content).

Unfortunately, there is not currently a means for enabling a user to selectively record user-designated metaverse collaboration content.

The embodiments of the present disclosure provide a means for selectively recording user-designated metaverse collaboration content by utilizing contextual boundaries in the collaborative environment of the metaverse. A “collaborative environment,” as used herein, refers to the digital or virtual reality environment of the metaverse that consists of avatars and shared digital content. “Contextual boundaries,” as used herein, refer to designations in the collaborative environment, including participants and collaboration content being shared in the collaborative environment, based on the context (interrelated conditions) of the collaborative environment. For example, contextual boundaries may include the particular presentation materials being shared, a particular avatar in connection with such presentation materials, etc. After the user provides such contextual boundaries, in one embodiment, the user provides the workflow sequence. A “workflow sequence,” as used herein, refers to the order of the selective recording in the collaborative environment of the metaverse. In particular, the workflow sequence defines the portions (e.g., views of the collaborative environment, particular slides of the shared digital content) of the contextual boundaries as well as the sequence or order in which such portions are to be recorded. For example, the user may define a workflow sequence with the order of first recording a slide from the shared digital presentation followed by recording the slide from the digital presentation along with the avatar of the presenter followed by recording a view of the entire collaborative environment (digital or virtual reality environment of the metaverse that consists of avatars and shared digital content) which includes the slide from the digital presentation, etc. In another example, the user may define a workflow sequence with the order of first recording the first 5 minutes of the slides from the shared digital presentation followed by recording the slide from the digital presentation along with the avatar of the presenter for the next 20 seconds followed by recording the next 5 minutes of the slides from the shared digital presentation. After receiving such a workflow sequence, metaverse collaboration content is selectively recorded in the collaborative environment using a recording node sequence based on such a workflow sequence. A second collaborative environment of the metaverse may then be created based on such a recording, which may be accessible to other users in a third collaborative environment via one or more nodes. A further discussion regarding these and other features is provided below.

In some embodiments of the present disclosure, the present disclosure comprises a computer-implemented method, system and computer program product for selectively recording metaverse collaboration content. In one embodiment of the present disclosure, contextual boundaries to perform selective recording in a collaborative environment of a metaverse are received from a user. A “collaborative environment,” as used herein, refers to the digital or virtual reality environment of the metaverse that consists of avatars and shared digital content. Furthermore, “contextual boundaries,” as used herein, refer to designations in the collaborative environment, including participants and collaboration content being shared in the collaborative environment, based on the context (interrelated conditions) of the collaborative environment. For example, contextual boundaries may include the particular presentation materials being shared, a particular avatar in connection with such presentation materials, etc. In addition to receiving contextual boundaries, a workflow sequence is received from the user. A “workflow sequence,” as used herein, refers to the order of the selective recording in the collaborative environment of the metaverse. In particular, the workflow sequence defines the portions (e.g., views of the collaborative environment, particular slides of the shared digital content) of the contextual boundaries as well as the sequence or order in which such portions are to be recorded. Metaverse collaboration content in the collaborative environment is then recorded using a recording node sequence based on the workflow sequence. In one embodiment, such a recording is accomplished by merging different portions of the contextual boundaries via nodes. “Nodes,” as used herein, are computing devices that are responsible for generating different portions of the collaborative environment, such as the avatar of the presenter, the shared digital presentation, the avatars of the students, street views, cars, etc. In one embodiment, a recording node sequence is generated to assist in the recording of the metaverse collaboration content in the collaborative environment. For example, the recording node sequence of nodes 1, 3 and 5 may be generated, which corresponds to the nodes that generate the content in the sequence indicated in the workflow sequence. A second collaborative environment of the metaverse may then be created based on the recorded metaverse collaboration content. In this manner, user-designated metaverse collaboration content in the metaverse may be selectively recorded.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

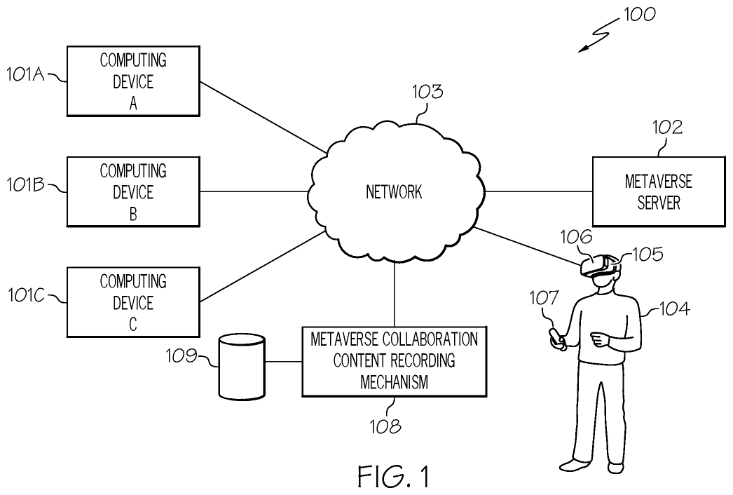

Referring now to the Figures in detail, FIG. 1 illustrates an embodiment of the present disclosure of a communication system 100 for practicing the principles of the present disclosure. Communication system 100 includes computing devices 101A-101C (identified as “Computing Device A,” “Computing Device B,” and “Computing Device C,” respectively, in FIG. 1) connected to a metaverse server 102 via a network 103. Computing devices 101A-101C may collectively or individually be referred to as computing devices 101 or computing device 101, respectively.

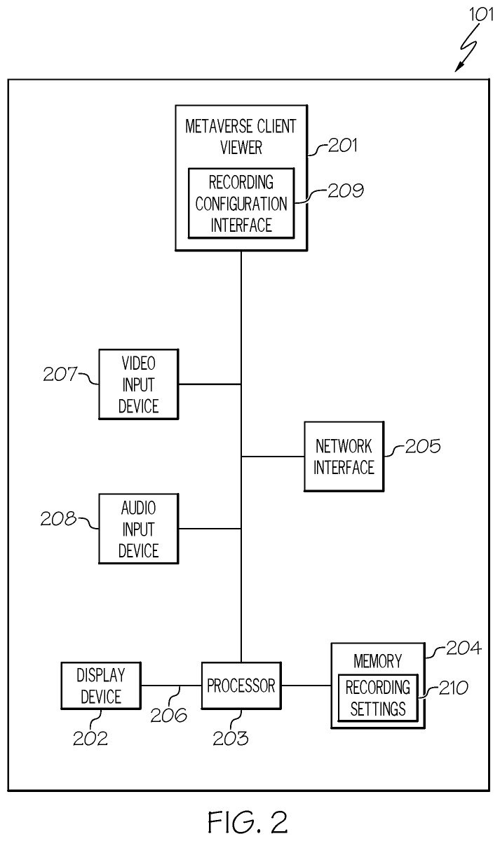

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 101 and metaverse server 102. It is noted that both computing device 101 and the user of computing device 101 may be identified with element number 101. A description of the hardware configuration of computing device 101 is provided further below in connection with FIG. 2.

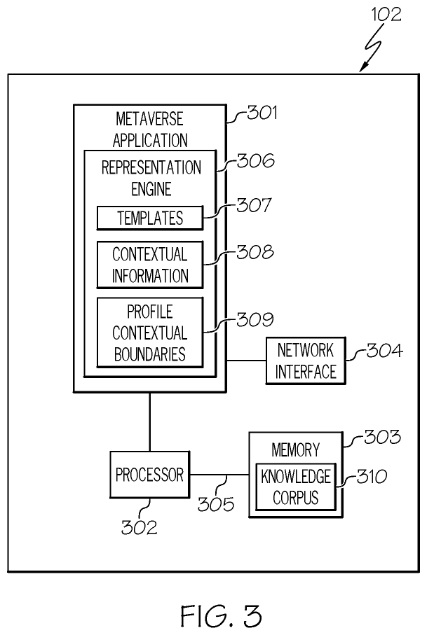

Metaverse server 102 hosts a simulated virtual world, or a metaverse, for a plurality of computing devices 101. As discussed above, a “metaverse” refers to any digital or virtual reality platform that combines any combination of aspects from online gaming, social media, virtual reality, augmented reality, cryptocurrencies or non-fungible tokens (NFTs) for users to interact with one another. In one embodiment, metaverse server 102 is an array of servers. In one embodiment, a specified area of the metaverse is simulated by a single server instance, and multiple server instances may be run on a single metaverse server 102. In some embodiments, metaverse server 102 includes a plurality of simulation servers dedicated to physics simulation in order to manage interactions and handle collisions between characters and objects in a metaverse. In one embodiment, metaverse server 102 also may include a plurality of storage servers, apart from the plurality of simulation servers, dedicated to storing data related to objects and characters in the metaverse world. The data stored on the plurality of storage servers may include object shapes, avatar profiles and appearances, audio clips, metaverse related scripts and other metaverse related objects. A description of the hardware configuration of metaverse server 102 is provided further below in connection with FIG. 3.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

Furthermore, system 100 is configured to allow a user 104 (who could also be a user of computing device 101) to participate in the metaverse. In one embodiment, user 104 may wear a virtual reality (VR)/augmented reality (AR) headset 105 that includes a display 106 providing a graphical environment for VR/AR generation. The graphical environment includes graphical images and/or computer-generated perceptual information. Display 106 encompasses part or all of a user's field of view.

Exemplary embodiments of headset 105 include a visor, a helmet, goggles, glasses and other similar arrangements. Examples of VR/AR headsets 105 include the HMD Odyssey™ from Samsung® Electronics, the ASUS® mixed reality headset from AsusTek Computer, Inc., the Lenovo Explorer® from Lenovo® as well as the mixed reality headsets from HP®, Acer® and Dell®. Furthermore, in one embodiment, headset 105 may include any one or more of the following: headphones to provide auditory feedback, vibration means to provide vibration feedback, and other sensors placed on or around the forward facing surface when in use.

Additionally, headset 105 may be utilized in conjunction with one or more motion controllers 107 used to track motion via the movement of the hand(s) of user 104.

Furthermore, as shown in FIG. 1, system 100 includes a metaverse collaboration content recording mechanism 108 connected to network 103. In one embodiment, metaverse collaboration content recording mechanism 108 is configured to enable a user of computing device 101 or user 104 to selectively record user-designated metaverse collaboration content by utilizing contextual boundaries in the collaborative environment of the metaverse, where such contextual boundaries are provided by the user (e.g., user of computing device 101, user 104). A “collaborative environment,” as used herein, refers to the digital or virtual reality environment of the metaverse that consists of avatars and shared digital content. “Contextual boundaries,” as used herein, refer to designations in the collaborative environment, including participants and collaboration content being shared in the collaborative environment, based on the context (interrelated conditions) of the collaborative environment. For example, contextual boundaries may include the particular presentation materials being shared, a particular avatar in connection with such presentation materials, etc. Contextual boundaries that are provided by the user are referred to herein as simply “contextual boundaries” as opposed to “profile contextual boundaries,” which may be provided by an expert as discussed below. After the user, such as the user of computing device 101 or user 104, provides such contextual boundaries, in one embodiment, the user (e.g., user of computing device 101 or user 104) provides the workflow sequence to metaverse collaboration content recording mechanism 108. As stated above, a “workflow sequence,” as used herein, refers to the order of the selective recording in the collaborative environment of the metaverse. In particular, the workflow sequence defines the portions (e.g., views of the collaborative environment, particular slides of the shared digital content) of the contextual boundaries as well as the sequence or order in which such portions are to be recorded. For example, the user may define a workflow sequence with the order of first recording a slide from the shared digital presentation followed by recording the slide from the digital presentation along with the avatar of the presenter followed by recording a view of the entire collaborative environment (digital or virtual reality environment of the metaverse that consists of avatars and shared digital content) which includes the slide from the digital presentation, etc. In another example, the user may define a workflow sequence with the order of first recording the first 5 minutes of the slides from the shared digital presentation followed by recording the slide from the digital presentation along with the avatar of the presenter for the next 20 seconds followed by recording the next 5 minutes of the slides from the shared digital presentation. After receiving such a workflow, metaverse collaboration content recording mechanism 108 selectively records metaverse collaboration content in the collaborative environment using a recording node sequence (discussed further below) based on such a workflow sequence. In one embodiment, such a recording is accomplished by merging different portions of the contextual boundaries via nodes. “Nodes,” as used herein, are computing devices that are responsible for generating different portions of the collaborative environment, such as the avatar of the presenter, the shared digital presentation, the avatars of the students, street views, cars, etc. A second collaborative environment of the metaverse may then be created by metaverse collaboration content recording mechanism 108 based on such a recording, which may be accessible to other users in a third collaborative environment via one or more nodes.

In one embodiment, metaverse collaboration content recording mechanism 108 enables the user (e.g., user of computing device 101, user 104) to selectively record user-designated metaverse collaboration content if such a user is authorized to make such a recording. In one embodiment, if such a user is not authorized to make such a recording, the user may be able to obtain such authorization via payment.

In one embodiment, metaverse collaboration content recording mechanism 108 is configured to track the mobility of the content in the workflow sequence (e.g., movement of the avatar of the user, such as user 104), which will be recorded and made available in a second collaborative environment.

In one embodiment, metaverse collaboration content recording mechanism 108 is configured to create a third collaborative environment of the metaverse consisting of an authorized user(s) who have requested to join the second collaborative environment via one or more nodes.

In one embodiment, metaverse collaboration content recording mechanism 108 is configured to generate a knowledge corpus based on the profile contextual boundaries, templates and contextual information. A “knowledge corpus,” as used herein, refers to a collection or body of knowledge directed to collaborative environments of the metaverse. “Profile contextual boundaries,” just as the contextual boundaries provided by users (e.g., users of computing devices 101), refer to the designations, descriptions or labels in the collaborative environment, such as the participants and collaboration content being shared in the collaborative environment, based on the context (interrelated conditions) of the collaborative environment. In one embodiment, such profile contextual boundaries are provided by an expert. A “template,” as used herein, refers to a file that indicates the overall layout of one or more portions (e.g., avatar of the presenter with the shared digital presentation) of the collaborative environment. In one embodiment, such a template may be created by an expert, such as the developer of the collaborative environment. “Contextual information,” as used herein, refers to the information about the structure, content and context of one or more portions (e.g., avatar of the presenter with the shared digital presentation) of the collaborative environment. In one embodiment, such contextual information may be created by an expert, such as the developer of the collaborative environment.

In one embodiment, metaverse collaboration content recording mechanism 108 generates a recording node sequence to record the metaverse collaboration content in the collaborative environment based on the knowledge corpus and the workflow sequence. For example, metaverse collaboration content recording mechanism 108 may generate the recording node sequence of nodes 1, 3 and 5, which correspond to the nodes that generate the content in the sequence indicated in the workflow sequence. For instance, the recording node sequence of nodes 1, 3 and 5 generate the following content in the following sequence: generating a slide from the shared digital presentation followed by generating the slide from the digital presentation along with the avatar of the presenter followed by generating a view of the entire collaborative environment (digital or virtual reality environment of the metaverse that consists of avatars and shared digital content) which includes the slide from the digital presentation.

As a result, in one embodiment, metaverse collaboration content recording mechanism 108 records the metaverse collaboration content in the collaborative environment using a recording node sequence based on the workflow sequence.

In one embodiment, the metaverse collaboration content that is recorded by metaverse collaboration content recording mechanism 108 is stored in database 109 connected to metaverse collaboration content recording mechanism 108.

A further discussion regarding these and other features is provided below.

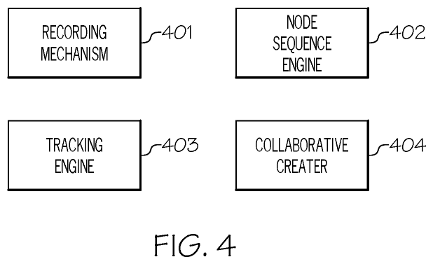

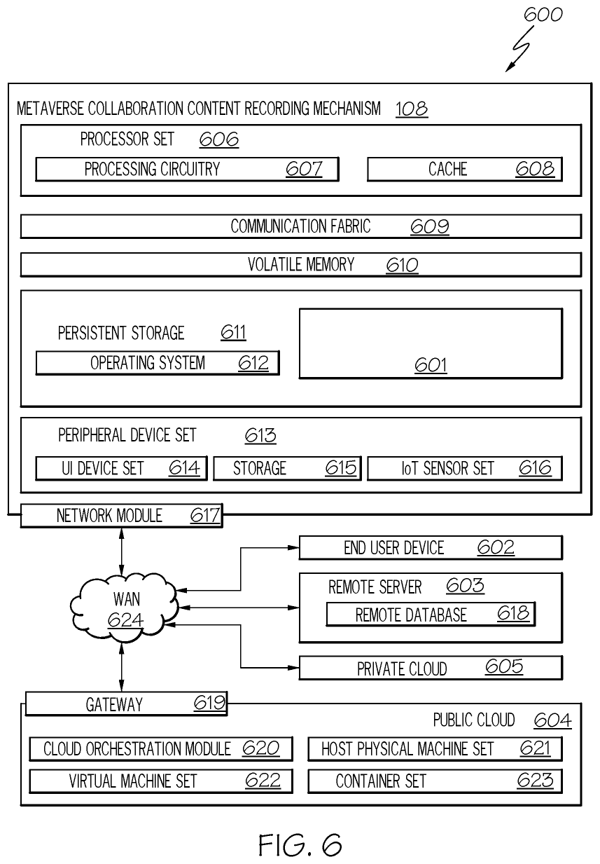

A description of the software components of metaverse collaboration content recording mechanism 108 for enabling the user (e.g., user of computing device 101, user 104) to selectively record user-designated metaverse collaboration content is provided below in connection with FIG. 4. A description of the hardware configuration of metaverse collaboration content recording mechanism 108 is provided further below in connection with FIG. 6.

System 100 is not to be limited in scope to any one particular network architecture. System 100 may include any number of computing devices 101, metaverse servers 102, networks 103, users 104, metaverse collaboration content recording mechanisms 108 and databases 109.

Referring now to FIG. 2, FIG. 2 illustrates a hardware configuration of computing device 101 (FIG. 1) in accordance with an embodiment of the present disclosure.

As shown in FIG. 2, computing device 101 includes a metaverse client viewer 201, a display device 202, a processor 203, a memory device 204, a network interface 205, a bus interface 206, a video input device 207, and an audio input device 208. In one embodiment, bus interface 206 facilitates communications related to software associated with metaverse client viewer 201 executing on computing device 101, including processing metaverse application commands, as well as storing, sending and receiving data packets associated with the application software of the metaverse. Although the depicted computing device 101 is shown and described herein with certain components and functionality, other embodiments of computing device 101 may be implemented with fewer or more components or with less or more functionality.

In one embodiment, metaverse client viewer 201 is stored in memory device 204 or a data storage device within computing device 101. In some embodiments, metaverse client viewer 201 includes processes and functions which are executed on processor 203 within computing device 101.

In one embodiment, metaverse client viewer 201 is a client program executed on computing device 101. In some embodiments, metaverse client viewer 201 enables a user of computing device 101 to connect to metaverse server 102 over network 103 as shown in FIG. 1. Metaverse client viewer 201 is further configured to enable a user of computing device 101 to interact with other users of computing devices 101 that are also connected to metaverse server 102. In one embodiment, metaverse client viewer 201 includes a recording configuration interface 209.

In one embodiment, recording configuration interface 209 is configured to allow the user to request metaverse collaboration content recording mechanism 108 to perform selective recording in a collaborative environment of the metaverse. Furthermore, recording configuration interface 209 is configured to allow the user to provide metaverse collaboration content recording mechanism 108 contextual boundaries and the workflow sequence.

In one embodiment, video input device 207 is configured to allow a user to control a facial expression and/or a gesture of the hands or fingers of the user's avatar in the metaverse virtual world. In other words, video input device 207 interprets the actual facial expression and/or actual gesture of the hands or fingers of the user. In one embodiment, video input device 207 sends a video signal or another signal of the facial expression and/or gesture of the hands or fingers of the user to processor 203.

In one embodiment, audio input device 208 allows a user to verbally speak to other users in the metaverse virtual world. In one embodiment, audio input device 208 sends an audio signal representative of the user's audio input to processor 203.

In some embodiments, display device 202 is a graphical display, such as a liquid crystal display (LCD) monitor, or another type of display device. In one embodiment, display device 202 is configured to convey a visual representation of a metaverse virtual world. In one embodiment, display device 202 allows a user to control and configure aspects of metaverse client viewer 201 as well as the processes related to representations of a user's avatar.

In one embodiment, processor 203 is a central processing unit (CPU) with one or more processing cores. In other embodiments, processor 203 is a graphical processing unit (GPU) or another type of processing device such as a general purpose processor, an application specific processor, a multi-core processor or a microprocessor. Alternatively, a separate GPU may be connected to display device 202. In general, processor 203 executes one or more instructions to provide operational functionality to computing device 101. The instructions may be stored locally in processor 203 or in memory device 204. Alternatively, the instructions may be distributed across one or more devices, such as the processor 203, memory device 204 or another data storage device.

The illustrated memory device 204 includes recording settings 210. In some embodiments, recording settings 210 are used in conjunction with the processes related to recording metaverse collaboration content. For example, such recording settings 210 provided by the user of computing device 101 include the contextual boundaries and workflow sequence discussed above. In some embodiments, memory device 204 is a random access memory (RAM) or another type of dynamic storage device. In other embodiments, memory device 204 is a read-only memory (ROM) or another type of static storage device. In other embodiments, the illustrated memory device 204 is representative of both RAM and static storage memory. In other embodiments, memory device 204 is an electronically programmable read-only memory (EPROM) or another type of storage device. Additionally, some embodiments store the instructions related to the operational functionality of computing device 101 as firmware, such as embedded foundation code, basic input/output system (BIOS) code or other similar code.

Network interface 205, in one embodiment, facilitates initial connections between computing device 101 and metaverse server 102 in response to a user on computing device 101 requesting to login to metaverse server 102 and to maintain a connection established between computing device 101 and metaverse server 102. In some embodiments, network interface 205 handles communications and commands between computing device 101 and metaverse server 102. The communications and commands are exchanged over network 103.

In one embodiment, display device 202, processor 203, memory device 204, network interface 205, and other components within computing device 101 may be connected to bus interface 206. Bus interface 206 may be configured for simplex or duplex communications of data, address and/or control information.

Referring now to FIG. 3, FIG. 3 illustrates a hardware configuration of metaverse server 102 in accordance with an embodiment of the present disclosure.

The illustrated metaverse server 102 includes a metaverse application 301, a processor 302, a memory device 303, a network interface 304 and one or more bus interfaces 305. In one embodiment, the illustrated metaverse application 301 includes a representation engine 306, which includes templates 307, contextual information 308 and profile contextual boundaries 309. In one embodiment, bus interfaces 305 facilitate communications related to the execution of metaverse application 301 on metaverse server 102, including processing metaverse application commands, as well as storing, sending and receiving data associated with metaverse application 301. Although the depicted metaverse server 102 is shown and described herein with certain components and functionality, other embodiments of the metaverse server 102 may be implemented with fewer or more components or with less or more functionality.

The illustrated metaverse server 102 of FIG. 3 includes many of the same or similar components as computing device of FIG. 2. These components are configured to operate in substantially the same manner described above, except as noted below.

In one embodiment, metaverse application 301, when executed on a metaverse server 102, simulates a fully immersive three-dimensional virtual space, or metaverse, that a user (e.g., user on a computing device 101) may enter and interact within via metaverse client viewer 201. Thus, several users, each on their own computing device 101, may interact with each other and with simulated objects within the metaverse.

In one embodiment, representation engine 306 provides functionality within metaverse application 301 to convey collaborative environments, where such collaborative environments may be simulated based on templates 307. As discussed above, a “template 307,” as used herein, refers to a file that indicates the overall layout of one or more portions (e.g., avatar of the presenter with the shared digital presentation) of the collaborative environment. In one embodiment, such a template may be created by an expert, such as the developer of the collaborative environment.

Furthermore, representation engine 306 provides functionality within metaverse application 301 to convey collaborative environments based on contextual information 308. As discussed above, “contextual information 308,” as used herein, refers to the information about the structure, content and context of one or more portions (e.g., avatar of the presenter with the shared digital presentation) of the collaborative environment. In one embodiment, such contextual information may be created by an expert, such as the developer of the collaborative environment.

Additionally, representation engine 306 provides functionality within metaverse application 301 to convey collaborative environments based on profile contextual boundaries 309. “Profile contextual boundaries 309,” just as the contextual boundaries provided by users (e.g., users of computing devices 101), refer to the designations, descriptions or labels in the collaborative environment, such as the participants and collaboration content being shared in the collaborative environment, based on the context (interrelated conditions) of the collaborative environment. For example, profile contextual boundaries 309 may include the particular presentation materials being shared, a particular avatar in connection with such presentation materials, etc. In one embodiment, such profile contextual boundaries 309 are created by an expert, such as the developer of the collaborative environment.

In one embodiment, memory device 303 stores a knowledge corpus 310 that is generated based on templates 307, contextual information 308 and profile contextual boundaries 309. Knowledge corpus 310, as used herein, refers to a collection or body of knowledge directed to collaborative environments of the metaverse. In particular, knowledge corpus 310 includes the layout of the collaborative environment as well as the structure, content and context of the portions of the collaborative environment, including the various designations, descriptions or labels in the collaborative environment. In one embodiment, knowledge corpus 310 is generated by metaverse collaboration content recording mechanism 108 based on templates 307, contextual information 308 and profile contextual boundaries 309 stored in metaverse server 102. In one embodiment, knowledge corpus 310 is additionally or alternatively stored in metaverse collaboration content recording mechanism 108. Based on such knowledge, a selective recording in a collaborative environment of the metaverse may be performed by metaverse collaboration content recording mechanism 108.

In one embodiment, processor 302 executes one or more instructions to provide operational functionality to metaverse server 102. The instructions may be stored locally in processor 302 or in memory device 303. Alternatively, the instructions may be distributed across one or more devices, such as processor 302, memory device 303 or another data storage device.

A discussion regarding the software components used by metaverse collaboration content recording mechanism 108 to selectively record metaverse collaboration content is provided below in connection with FIG. 4.

FIG. 4 is a diagram of the software components used by metaverse collaboration content recording mechanism 108 (FIG. 1) to selectively record metaverse collaboration content in accordance with an embodiment of the present disclosure.

As shown in FIG. 4, metaverse collaboration content recording mechanism 108 includes a recording mechanism 401 for recording metaverse collaboration content in the collaborative environment based on the contextual boundaries and workflow sequence provided by the user (e.g., user of computing device 101, user 104).

In one embodiment, recording mechanism 401 receive a request from a user (e.g., user of computing device 101, user 104) to perform selective recording in a collaborative environment of the metaverse based on one or more nodes. As discussed above, the user (e.g., user of computing device 101) may issue a request to metaverse collaboration content recording mechanism 108 to preform selective recording in a collaborative environment of the metaverse. Such a request is received by recording mechanism 401, which in one embodiment, determines whether the user is authorized to perform such a recording.

In one embodiment, recording mechanism 401 determines whether the user is authorized to perform selective recording in a collaborative environment of the metaverse by performing a lookup in a data structure (e.g., table), which includes a listing of users who are authorized to perform such a recording. In one embodiment, such users are listed according to identifiers, such as the user's login identification used to login to metaverse server 102. In one embodiment, such users are designated as being authorized based on a previous payment to enable the user to utilize the service of selectively recording in a collaborative environment of the metaverse. In one embodiment, the data structure is populated by an expert. In one embodiment, the data structure is stored in a storage device of metaverse collaboration content recording mechanism 108.

In one embodiment, if the user is deemed to not be authorized to perform selective recording in a collaborative environment of the metaverse, then, in one embodiment, recording mechanism 401 determines if the user has the option to record based on payment. In one embodiment, recording mechanism 401 makes such a determination based on performing a lookup in a data structure (e.g., table) containing a list of users who have the option to pay for such a service. In one embodiment, such users are listed according to identifiers, such as the user's login identification used to login to metaverse server 102. In one embodiment, the data structure is populated by an expert. In one embodiment, the data structure is stored in a storage device of metaverse collaboration content recording mechanism 108.

If the user does not have the option to record based on payment, then recording mechanism 401 informs the user (e.g., user of computing device 101, user 104) that the user is not authorized to perform selective recording. In one embodiment, such an indication is provided to the user (e.g., user of computing device 101, user 104) via electronic means, such as via an electronic message or an instant message.

If, however, the user has the option to record based on payment, then recording mechanism 401 requests the user (e.g., user of computing device 101, user 104) to provide payment in order to perform selective recording in the collaborative environment of the metaverse.

If the user does not provide such payment, such as within a user-designated amount of time, then recording mechanism 104 denies the user (e.g., user of computing device 101, user 104) the ability to perform selective recording in the collaborative environment of the metaverse.

If, however, the user is authorized to perform selective recording in a collaborative environment of the metaverse or provides payment to perform selective recording in a collaborative environment of the metaverse, then, in one embodiment, recording mechanism 104 issues a request to the user (e.g., user of computing device 101, user 104) to provide contextual boundaries and the workflow sequence. In one embodiment, such a request is provided to the user (e.g., user of computing device 101, user 104) via electronic means, such as via an electronic message or an instant message.

As discussed above, “contextual boundaries,” as used herein, refer to designations in the collaborative environment, including participants and collaboration content being shared in the collaborative environment, based on the context (interrelated conditions) of the collaborative environment. For example, contextual boundaries may include the particular presentation materials being shared, a particular avatar in connection with such presentation materials, etc. In one embodiment, such contextual boundaries are defined via hand or finger gestures from the user (e.g., user of computing device 101, user 104). In one embodiment, such contextual boundaries are defined by the user (e.g., user of computing device 101, user 104) inside the metaverse collaborative surrounding.

A “workflow sequence,” as used herein, refers to the order of the selective recording in the collaborative environment of the metaverse. In particular, the workflow sequence defines the portions (e.g., views of the collaborative environment, particular slides of the shared digital content) of the contextual boundaries as well as the sequence or order in which such portions are to be recorded. For example, the user may define a workflow sequence with the order of first recording a slide from the shared digital presentation followed by recording the slide from the digital presentation along with the avatar of the presenter followed by recording a view of the entire collaborative environment (digital or virtual reality environment of the metaverse that consists of avatars and shared digital content) which includes the slide from the digital presentation, etc. In another example, the user may define a workflow sequence with the order of first recording the first 5 minutes of the slides from the shared digital presentation followed by recording the slide from the digital presentation along with the avatar of the presenter for the next 20 seconds followed by recording the next 5 minutes of the slides from the shared digital presentation.

After receiving such a workflow sequence, recording mechanism 401 selectively records metaverse collaboration content in the collaborative environment based on such a workflow sequence. In one embodiment, such a recording is accomplished by merging different portions of the contextual boundaries via nodes. “Nodes,” as used herein, are computing devices that are responsible for generating different portions of the collaborative environment, such as the avatar of the presenter, the shared digital presentation, the avatars of the students, street views, cars, etc. In one embodiment, a recording node sequence is generated to assist in the recording of the metaverse collaboration content in the collaborative environment as discussed below.

As shown in FIG. 4, metaverse collaboration content recording mechanism 108 further includes a node sequence engine 402 configured to generate a recording node sequence to record the metaverse collaboration content in the collaborative environment based on a knowledge corpus and the workflow sequence.

Referring to FIGS. 3 and 4, in one embodiment, node sequence engine 402 is configured to generate a knowledge corpus (e.g., knowledge corpus 310) based on profile contextual boundaries 309, templates 307 and contextual information 308. As discussed above, “knowledge corpus,” as used herein, refers to a collection or body of knowledge directed to collaborative environments of the metaverse. “Profile contextual boundaries 309,” just as the contextual boundaries provided by users (e.g., users of computing devices 101), refer to the designations, descriptions or labels in the collaborative environment, such as the participants and collaboration content being shared in the collaborative environment, based on the context (interrelated conditions) of the collaborative environment. In one embodiment, such profile contextual boundaries 309 that are used to generate the knowledge corpus are provided by an expert, such as the developer of the collaborative environment. Furthermore, as discussed above, a “template 307,” as used herein, refers to a file that indicates the overall layout of one or more portions (e.g., avatar of the presenter with the shared digital presentation) of the collaborative environment. In one embodiment, such a template may be created by an expert, such as the developer of the collaborative environment. “Contextual information 308,” as used herein, refers to the information about the structure, content and context of one or more portions (e.g., avatar of the presenter with the shared digital presentation) of the collaborative environment. In one embodiment, such contextual information may be created by an expert, such as the developer of the collaborative environment.

As discussed above, the “workflow sequence” refers to the order of the selective recording in the collaborative environment of the metaverse. In particular, the workflow sequence defines the portions (e.g., views of the collaborative environment, particular slides of the shared digital content) of the contextual boundaries as well as the sequence or order in which such portions are to be recorded. In one embodiment, node sequence engine 402 is configured to map the order in which such portions are to be recorded to the nodes utilized for generating such portions of the collaborative environment, such as the avatar of the presenter, the shared digital presentation, the avatars of the students, street views, cars, etc. In one embodiment, such mapping may be obtained via the use of a data structure (e.g., table) that contains a listing of the nodes and the associated portions of the collaborative environment that such nodes are responsible for generating the content (e.g., avatars, digital presentation, street views, etc.) in such portions of the collaborative environment. In one embodiment, such a data structure is populated by an expert. In one embodiment, such a data structure resides within the storage device of metaverse collaboration content recording mechanism 108. Hence, based on the sequence or order in which such portions are to be recorded, node sequence engine 402 determines the sequence of nodes (“recording node sequence”) to generate such portions of the collaborative environment based on such a data structure.

Furthermore, in one embodiment, such a node sequence (“recording node sequence”) used to record the metaverse collaboration content in the collaborative environment is based on the knowledge corpus, which may be used to predict and recommend recording node sequences. For example, profile contextual boundaries 309, templates 307 and contextual information 308 of the knowledge corpus, such as knowledge corpus 310, provides details as to the portions of the collaborative environment, the layout of such portions as well as the structure, content and context of such portions. Based on the workflow sequence, which defines the order of the portions of the collaborative environment to be recorded, the details about such portions of the collaborative environment, the layout of such portions as well as the structure, content and context of such portions can be obtained from the knowledge corpus, such as knowledge corpus 310. Nodes that are utilized to generate such details, layouts, structure, content and context may then be identified by node sequence engine 402 via a data structure (e.g., table) which maps such nodes to such details, layouts, structure, content and context. In one embodiment, such a data structure is populated by an expert. In one embodiment, such a data structure resides within the storage device of metaverse collaboration content recording mechanism 108. Hence, based on the knowledge corpus, such as knowledge corpus 310, and workflow sequence, node sequence engine 402 determines the sequence of nodes (“recording node sequence”) to generate such portions of the collaborative environment in the order specified by the workflow sequence based on such a data structure.

In one embodiment, recording mechanism 401 utilizes such a recording node sequence to record the metaverse collaboration content in the collaborative environment based on the workflow sequence. In one embodiment, recording mechanism 401 utilizes a software tool, such as VRCLens, which is a set of photographic extensions to the stock VRChat® camera that could be placed in an avatar. In one embodiment, such a tool includes zooming, depth of field simulation, image stabilization, avatar-detect autofocus (only focus on the avatar and ignore the scenery), etc.

In one embodiment, as discussed above, the mobility of the content in the workflow sequence (e.g., movement of the avatar in the collaborative environment) is tracked by tracking engine 403 of metaverse collaboration content recording mechanism 108. In one embodiment, tracking engine 403 utilizes a software tool, such as VRCLens, for tracking the movement or mobility of the content in the workflow sequence. Other software tools for tracking the movement or mobility of the content in the workflow sequence include, but not limited to, WEbXR, Blender™, Xsens®, etc.

In one embodiment, recording mechanism 401 utilizes a software tool, such as VRCLens, to record the tracked mobile content (e.g., movement of the avatar in the collaborative environment).

In one embodiment, such recording of the selective portions of the contextual boundaries as defined by the workflow sequence is performed asynchronously or linearly by recording mechanism 401.

In one embodiment, such recorded content (recorded metaverse collaboration content) is stored in database 109.

In one embodiment, the recording performed by recording mechanism 401 is terminated upon the termination of the session or when the recording is autonomously marked completed, such as by the user (e.g., user of computing device 101, user 104). In one embodiment, the termination of the recoding is indicated by the workflow session, which identifies an event, time or action upon which recording of the collaboration content is to be terminated.

Furthermore, as shown in FIG. 4, metaverse collaboration content recording mechanism 108 includes collaborative environment creator 404 configured to create collaborative environments of the metaverse. For example, the metaverse collaboration content that was recorded by recording mechanism 401 in a collaborative environment may be used by collaborative environment creator 404 to create a second collaborative environment of the metaverse.

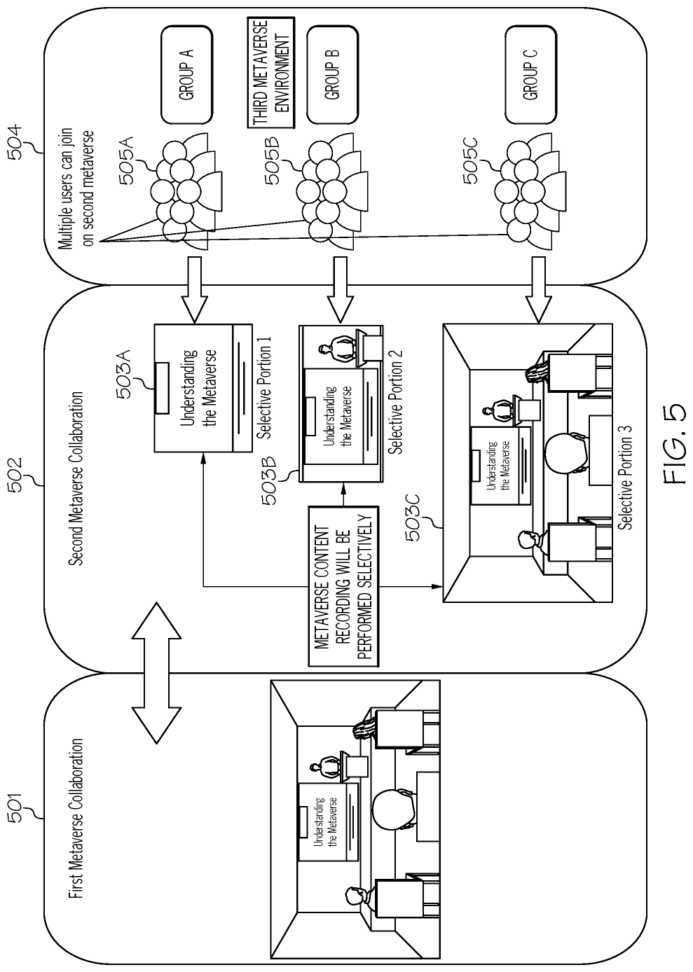

In one embodiment, the second collaborative environment of the metaverse is created based on the portions of the contextual boundaries defined by the workflow sequence to be recorded via one or more nodes as shown in FIG. 5.

FIG. 5 illustrates creating collaborative environments in the metaverse in accordance with an embodiment of the present disclosure.

Referring to FIG. 5, FIG. 5 illustrates a first collaborative environment 501, where recording mechanism 401 selectively records metaverse collaboration content in the collaborative environment, such as the first collaborative environment 501, using a recording node sequence based on the workflow sequence. Furthermore, such recording includes recording the tracked mobile content (e.g., movement of the avatar in the collaborative environment).

As further shown in FIG. 5, collaborative environment creator 404 creates a second collaborative environment 502 comprised of selective portions of the metaverse collaboration content in the first collaborative environment 501 that was recorded by recording mechanism 401. As stated above, a “collaborative environment,” as used herein, refers to the digital or virtual reality environment of the metaverse that consists of avatars and shared digital content. For example, such selective portions 503A-503C (identified as “Selective Portion 1,” “Selective Portion 2,” and “Selective Portion 3,” respectively) are utilized to create the second collaborative environment 502. For instance, selective portion 503A is directed to the shared digital presentation content, selective portion 503B is directed to the presenter along with the shared digital presentation content and selective portion 503C is directed to the audience (students) along with the presenter sharing the digital presentation content.

One or more further collaborative environments of the metaverse can be created by collaborative environment creator 404 based on the second collaborative environment 502. For example, as shown in FIG. 5, a third collaborative environment 504 is created consisting of groups of users (user groups) 505A-505C (e.g., users of computing devices 101) joining the second collaborative environment 502 of the metaverse via one or more nodes. User groups 505A-505C may consist of a groups of users (identified as “Group A,” “Group B,” and “Group C,” respectively), where multiple users from each of these groups may join the second collaborative environment 502 of the metaverse, including at different selective portions 503, in the created third collaborative environment 504. For example, users from user group 505A may join the second collaborative environment 502 of the metaverse at selective portion 503A. Users from user group 505B may join the second collaborative environment 502 of the metaverse at selective portion 503B. Furthermore, users from user group 505C may join the second collaborative environment 502 of the metaverse at selective portion 503C. User groups 505A-505C may collectively or individually be referred to as user groups 505 or user group 505, respectively.

While only a third collaborative environment 504 is shown being created in FIG. 5, collaborative environment creator 404 may create additional collaborative environments, including additional collaborative environments based on the second collaborative environment 502 as discussed above or even based on the third collaborative environment 504 and so forth. Such other collaborative environments are created based on new workflow sequences being received from the user, which are utilized by recording mechanism 401 to record metaverse collaboration content in one of these collaborative environments using a recording node sequence based on such a workflow sequence as discussed above. Such recorded metaverse collaboration content is then used by collaborative environment creator 404 to create a new collaborative environment.

In one embodiment, collaborative environment creator 404 creates such collaborative environments, including based on the recorded metaverse collaboration content, using various software tools, including, but not limited to, Gather®, Decentraland®, AltspaceVR®, Magic Leap®, Wonder, etc.

In one embodiment, collaborative environment creator 404 creates such collaborative environments by designing the metaspace (conceptual space occupied by virtual objects of the metaverse) of the collaborative environment based on the recorded metaverse collaboration content (e.g., avatars, digital presentation content, virtual meeting room, etc.). In one embodiment, after designing the metaspace of the collaborative environment, collaborative environment creator 404 builds an interaction layer in order for users to interact with others in the collaborative environment. In one embodiment, such an interaction layer includes user controls, navigation controls, communication protocols, access criteria, etc. In one embodiment, the design of the metaspace and building of the interaction layer is accomplished by collaborative environment creator 404 using various software tools, including, but not limited to, Gather®, Decentraland®, AltspaceVR®, Magic Leap®, Wonder, etc.

In one embodiment, collaborative environment creator 404 receives requests from users (e.g., users from user group 505) to join the newly created collaborative environment, such as second collaborative environment 502. Upon receiving such requests, collaborative environment creator 404 creates a third collaboration environment 504 of the metaverse by joining such users from user groups 505 to second collaborative environment 502 of the metaverse via one or more nodes.

In one embodiment, collaborative environment creator 404 determines whether such users requesting to join the newly created collaborative environment, such as second collaborative environment 502, have permission or are authorized to join such a newly created collaborative environment. In one embodiment, collaborative environment creator 404 makes such a determination based on performing a lookup in a data structure (e.g., table), which includes a listing of users who are authorized to join collaborative environments. In one embodiment, such users are listed according to identifiers, such as the user's login identification used to login to metaverse server 102. In one embodiment, such users are designated as being authorized based on a previous payment to enable the user to utilize the service of selectively recording in a collaborative environment of the metaverse. In one embodiment, the data structure is populated by an expert. In one embodiment, the data structure is stored in a storage device of metaverse collaboration content recording mechanism 108.

In one embodiment, if the user is deemed to not be authorized to join such a newly created collaborative environment, then, in one embodiment, collaborative environment creator 404 informs the user (e.g., user of user group 505) that the user is not authorized to join the newly created collaborative environment (e.g., collaborative environment 502) via electronic means, such as via an electronic message or an instant message.

If, however, the user is deemed to be authorized to join such a newly created collaborative environment, then, in one embodiment, collaborative environment creator 404 joins the user to the newly created collaborative environment (e.g., collaborative environment 502) via a further created collaborative environment (e.g., collaborative environment 504).

A further description of these and other features is provided below in connection with the discussion of the method for selectively recording metaverse collaboration content.

Prior to the discussion of the method for selectively recording metaverse collaboration content, a description of the hardware configuration of metaverse collaboration content recording mechanism 108 (FIG. 1) is provided below in connection with FIG. 6.

Referring now to FIG. 6, in conjunction with FIG. 1, FIG. 6 illustrates an embodiment of the present disclosure of the hardware configuration of metaverse collaboration content recording mechanism 108 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code (stored in block 601) involved in performing the disclosed methods, such as selectively recording metaverse collaboration content. In addition to block 601, computing environment 600 includes, for example, metaverse collaboration content recording mechanism 108, wide area network (WAN) 624 (in one embodiment, WAN 624 corresponds to network 103 of FIG. 1), end user device (EUD) 602, remote server 603, public cloud 604, and private cloud 605. In this embodiment, metaverse collaboration content recording mechanism 108 includes processor set 606 (including processing circuitry 607 and cache 608), communication fabric 609, volatile memory 610, persistent storage 611 (including operating system 612 and block 601, as identified above), peripheral device set 613 (including user interface (UI) device set 614, storage 615, and Internet of Things (IoT) sensor set 616), and network module 617. Remote server 603 includes remote database 618. Public cloud 604 includes gateway 619, cloud orchestration module 620, host physical machine set 621, virtual machine set 622, and container set 623.

Metaverse collaboration content recording mechanism 108 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 618. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically metaverse collaboration content recording mechanism 108, to keep the presentation as simple as possible. Metaverse collaboration content recording mechanism 108 may be located in a cloud, even though it is not shown in a cloud in FIG. 6. On the other hand, metaverse collaboration content recording mechanism 108 is not required to be in a cloud except to any extent as may be affirmatively indicated.

Processor set 606 includes one, or more, computer processors of any type now known or to be developed in the future. Processing circuitry 607 may be distributed over multiple packages, for example, multiple, coordinated integrated circuit chips. Processing circuitry 607 may implement multiple processor threads and/or multiple processor cores. Cache 608 is memory that is located in the processor chip package(s) and is typically used for data or code that should be available for rapid access by the threads or cores running on processor set 606. Cache memories are typically organized into multiple levels depending upon relative proximity to the processing circuitry. Alternatively, some, or all, of the cache for the processor set may be located “off chip.” In some computing environments, processor set 606 may be designed for working with qubits and performing quantum computing.

Computer readable program instructions are typically loaded onto metaverse collaboration content recording mechanism 108 to cause a series of operational steps to be performed by processor set 606 of metaverse collaboration content recording mechanism 108 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 608 and the other storage media discussed below. The program instructions, and associated data, are accessed by processor set 606 to control and direct performance of the disclosed methods. In computing environment 600, at least some of the instructions for performing the disclosed methods may be stored in block 601 in persistent storage 611.

Communication fabric 609 is the signal conduction paths that allow the various components of metaverse collaboration content recording mechanism 108 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 610 is any type of volatile memory now known or to be developed in the future. Examples include dynamic type random access memory (RAM) or static type RAM. Typically, the volatile memory is characterized by random access, but this is not required unless affirmatively indicated. In metaverse collaboration content recording mechanism 108, the volatile memory 610 is located in a single package and is internal to metaverse collaboration content recording mechanism 108, but, alternatively or additionally, the volatile memory may be distributed over multiple packages and/or located externally with respect to metaverse collaboration content recording mechanism 108.

Persistent Storage 611 is any form of non-volatile storage for computers that is now known or to be developed in the future. The non-volatility of this storage means that the stored data is maintained regardless of whether power is being supplied to metaverse collaboration content recording mechanism 108 and/or directly to persistent storage 611. Persistent storage 611 may be a read only memory (ROM), but typically at least a portion of the persistent storage allows writing of data, deletion of data and re-writing of data. Some familiar forms of persistent storage include magnetic disks and solid-state storage devices. Operating system 612 may take several forms, such as various known proprietary operating systems or open-source Portable Operating System Interface type operating systems that employ a kernel. The code included in block 601 typically includes at least some of the computer code involved in performing the disclosed methods.

Peripheral device set 613 includes the set of peripheral devices of metaverse collaboration content recording mechanism 108. Data communication connections between the peripheral devices and the other components of metaverse collaboration content recording mechanism 108 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 614 may include components such as a display screen, speaker, microphone, wearable devices (such as goggles and smart watches), keyboard, mouse, printer, touchpad, game controllers, and haptic devices. Storage 615 is external storage, such as an external hard drive, or insertable storage, such as an SD card. Storage 615 may be persistent and/or volatile. In some embodiments, storage 615 may take the form of a quantum computing storage device for storing data in the form of qubits. In embodiments where metaverse collaboration content recording mechanism 108 is required to have a large amount of storage (for example, where metaverse collaboration content recording mechanism 108 locally stores and manages a large database) then this storage may be provided by peripheral storage devices designed for storing very large amounts of data, such as a storage area network (SAN) that is shared by multiple, geographically distributed computers. IoT sensor set 616 is made up of sensors that can be used in Internet of Things applications. For example, one sensor may be a thermometer and another sensor may be a motion detector.

Network module 617 is the collection of computer software, hardware, and firmware that allows metaverse collaboration content recording mechanism 108 to communicate with other computers through WAN 624. Network module 617 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 617 are performed on the same physical hardware device. In other embodiments (for example, embodiments that utilize software-defined networking (SDN)), the control functions and the forwarding functions of network module 617 are performed on physically separate devices, such that the control functions manage several different network hardware devices. Computer readable program instructions for performing the disclosed methods can typically be downloaded to metaverse collaboration content recording mechanism 108 from an external computer or external storage device through a network adapter card or network interface included in network module 617.

WAN 624 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 602 is any computer system that is used and controlled by an end user (for example, a customer of an enterprise that operates metaverse collaboration content recording mechanism 108), and may take any of the forms discussed above in connection with metaverse collaboration content recording mechanism 108. EUD 602 typically receives helpful and useful data from the operations of metaverse collaboration content recording mechanism 108. For example, in a hypothetical case where metaverse collaboration content recording mechanism 108 is designed to provide a recommendation to an end user, this recommendation would typically be communicated from network module 617 of metaverse collaboration content recording mechanism 108 through WAN 624 to EUD 602. In this way, EUD 602 can display, or otherwise present, the recommendation to an end user. In some embodiments, EUD 602 may be a client device, such as thin client, heavy client, mainframe computer, desktop computer and so on.

Remote server 603 is any computer system that serves at least some data and/or functionality to metaverse collaboration content recording mechanism 108. Remote server 603 may be controlled and used by the same entity that operates metaverse collaboration content recording mechanism 108. Remote server 603 represents the machine(s) that collect and store helpful and useful data for use by other computers, such as metaverse collaboration content recording mechanism 108. For example, in a hypothetical case where metaverse collaboration content recording mechanism 108 is designed and programmed to provide a recommendation based on historical data, then this historical data may be provided to metaverse collaboration content recording mechanism 108 from remote database 618 of remote server 603.

Public cloud 604 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 604 is performed by the computer hardware and/or software of cloud orchestration module 620. The computing resources provided by public cloud 604 are typically implemented by virtual computing environments that run on various computers making up the computers of host physical machine set 621, which is the universe of physical computers in and/or available to public cloud 604. The virtual computing environments (VCEs) typically take the form of virtual machines from virtual machine set 622 and/or containers from container set 623. It is understood that these VCEs may be stored as images and may be transferred among and between the various physical machine hosts, either as images or after instantiation of the VCE. Cloud orchestration module 620 manages the transfer and storage of images, deploys new instantiations of VCEs and manages active instantiations of VCE deployments. Gateway 619 is the collection of computer software, hardware, and firmware that allows public cloud 604 to communicate through WAN 624.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 605 is similar to public cloud 604, except that the computing resources are only available for use by a single enterprise. While private cloud 605 is depicted as being in communication with WAN 624 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 604 and private cloud 605 are both part of a larger hybrid cloud.

Block 601 further includes the software components discussed above in connection with FIGS. 4-5 to selectively record metaverse collaboration content. In one embodiment, such components may be implemented in hardware. The functions discussed above performed by such components are not generic computer functions. As a result, metaverse collaboration content recording mechanism 108 is a particular machine that is the result of implementing specific, non-generic computer functions.

In one embodiment, the functionality of such software components of metaverse collaboration content recording mechanism 108, including the functionality for selectively recording metaverse collaboration content, may be embodied in an application specific integrated circuit.

As stated above, the term “metaverse” refers to any digital or virtual reality platform that combines any combination of aspects from online gaming, social media, virtual reality, augmented reality, cryptocurrencies or non-fungible tokens (NFTs) for users to interact with one another. The term “metaverse” originated in the 1992 science fiction novel Snow Crash as a portmanteau of “meta” and “universe.” Metaverse development is often linked to advancing virtual reality technology due to the increasing demands for immersion. Recent interest in metaverse development is influenced by Web3, a concept for a decentralized iteration of the Internet. However, metaverse worlds are not necessarily a uniquely Web3 aspect. For example, the online gaming platform Roblox is considered to be a metaverse world, though it does not use cryptocurrency, NFTs, or blockchain technology on the platform. In contrast, the virtual world Decentraland is an entirely Web3-based platform that utilizes NFTs, cryptocurrencies, decentralized storage and blockchain networks on the backend. An example of a metaverse environment consists of a mixed reality meeting where the users are wearing virtual reality headsets in their virtual offices. After finishing the meeting, a user may relax by playing a blockchain-based game and then managing a crypto portfolio while inside the metaverse. While attending a metaverse collaboration (group of users interacting in the metaverse), a user may want to selectively and autonomously record the metaverse collaboration content. For example, while attending a metaverse collaboration, such as a learning session, where a presenter is sharing digital presentation contents to students, a user may want to selectively record the presentation content, the presentation content along with the presenter (as an avatar) or the entire metaverse collaboration (the avatars of the presenter and students along with the presentation content). Unfortunately, there is not currently a means for enabling a user to selectively record user-designated metaverse collaboration content.

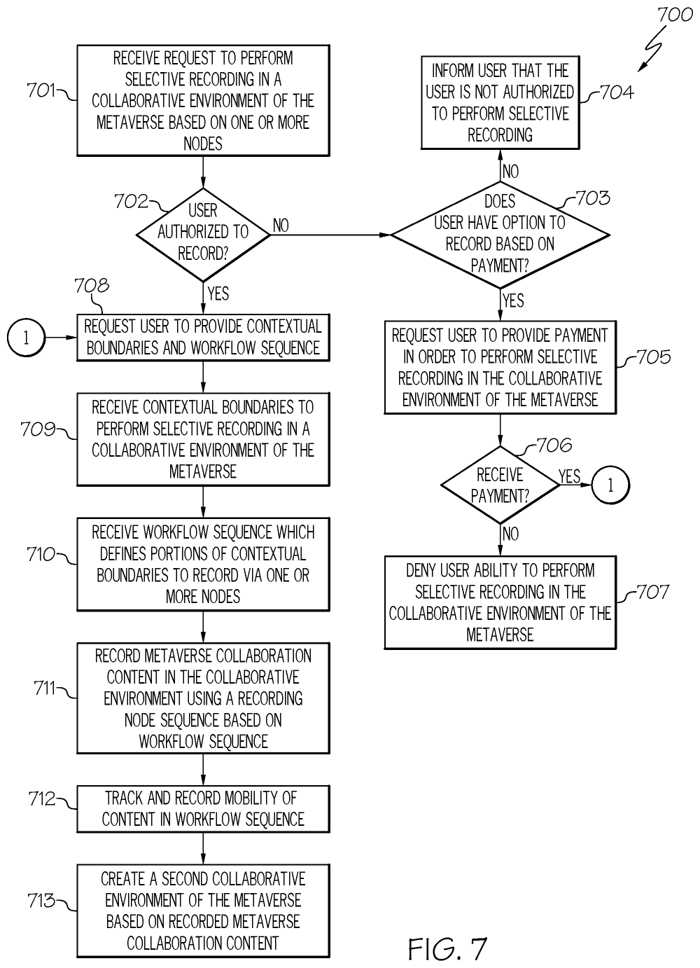

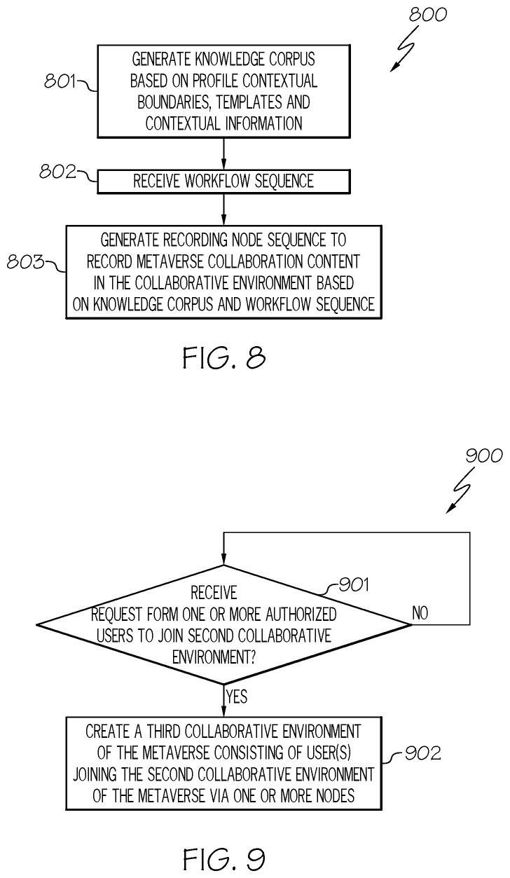

The embodiments of the present disclosure provide a means for selectively recording user-designated metaverse collaboration content by utilizing contextual boundaries in the collaborative environment of the metaverse as discussed below in connection with FIGS. 7-9. FIG. 7 is a flowchart of a method for selectively recording metaverse collaboration content. FIG. 8 is a flowchart of a method for generating the recording node sequence. FIG. 9 is a flowchart of a method for creating a third collaborative environment of the metaverse in response to authorized users joining the second collaborative environment of the metaverse created based on the recorded metaverse collaboration content.

As stated above, FIG. 7 is a flowchart of a method 700 for selectively recording metaverse collaboration content in accordance with an embodiment of the present disclosure.

Referring to FIG. 7, in conjunction with FIGS. 1-6, in operation 701, recording mechanism 401 of metaverse collaboration content recording mechanism 108 receives a request from a user (e.g., user of computing device 101, user 104) to perform selective recording in a collaborative environment of the metaverse based on one or more nodes.

In operation 702, recording mechanism 401 of metaverse collaboration content recording mechanism 108 determines whether the user (e.g., user of computing device 101, user 104) is authorized to perform such a recording.

As discussed above, in one embodiment, recording mechanism 401 determines whether the user is authorized to perform selective recording in a collaborative environment of the metaverse by performing a lookup in a data structure (e.g., table), which includes a listing of users who are authorized to perform such a recording. In one embodiment, such users are listed according to identifiers, such as the user's login identification used to login to metaverse server 102. In one embodiment, such users are designated as being authorized based on a previous payment to enable the user to utilize the service of selectively recording in a collaborative environment of the metaverse. In one embodiment, the data structure is populated by an expert. In one embodiment, the data structure is stored in a storage device (e.g., storage device 611,615) of metaverse collaboration content recording mechanism 108.

If the user (e.g., user of computing device 101, user 104) is not authorized to perform selective recording in a collaborative environment of the metaverse, then, in operation 703, recording mechanism 401 of metaverse collaboration content recording mechanism 108 determines if the user has the option to record based on payment.

As stated above, in one embodiment, recording mechanism 401 makes such a determination based on performing a lookup in a data structure (e.g., table) containing a list of users who have the option to pay for such a service. In one embodiment, such users are listed according to identifiers, such as the user's login identification used to login to metaverse server 102. In one embodiment, the data structure is populated by an expert. In one embodiment, the data structure is stored in a storage device (e.g., storage device 611, 615) of metaverse collaboration content recording mechanism 108.

If the user does not have the option to record based on payment, then, in operation 704, recording mechanism 401 of metaverse collaboration content recording mechanism 108 informs the user (e.g., user of computing device 101, user 104) that the user is not authorized to perform selective recording.

As discussed above, in one embodiment, such an indication is provided to the user (e.g., user of computing device 101, user 104) via electronic means, such as via an electronic message or an instant message.

If, however, the user has the option to record based on payment, then, in operation 705, recording mechanism 401 of metaverse collaboration content recording mechanism 108 requests the user (e.g., user of computing device 101, user 104) to provide payment in order to perform selective recording in the collaborative environment of the metaverse.

In operation 706, recording mechanism 401 of metaverse collaboration content recording mechanism 108 determines whether such payment has been received.

If the user does not provide such payment, such as within a user-designated amount of time, then, in operation 707, recording mechanism 104 of metaverse collaboration content recording mechanism 108 denies the user (e.g., user of computing device 101, user 104) the ability to perform selective recording in the collaborative environment of the metaverse.

If, however, the user does provide such payment, or if the user is authorized to record (see operation 702), then, in operation 708, recording mechanism 104 of metaverse collaboration content recording mechanism 108 issues a request to the user (e.g., user of computing device 101, user 104) to provide contextual boundaries and the workflow sequence.

As stated above, in one embodiment, such a request is provided to the user (e.g., user of computing device 101, user 104) via electronic means, such as via an electronic message or an instant message.

Furthermore, as discussed above, “contextual boundaries,” as used herein, refer to designations in the collaborative environment, including participants and collaboration content being shared in the collaborative environment, based on the context (interrelated conditions) of the collaborative environment. For example, contextual boundaries may include the particular presentation materials being shared, a particular avatar in connection with such presentation materials, etc. In one embodiment, such contextual boundaries are defined via hand or finger gestures from the user (e.g., user of computing device 101, user 104). In one embodiment, such contextual boundaries are defined by the user (e.g., user of computing device 101, user 104) inside the metaverse collaborative surrounding.

A “workflow sequence,” as used herein, refers to the order of the selective recording in the collaborative environment of the metaverse. In particular, the workflow sequence defines the portions (e.g., views of the collaborative environment, particular slides of the shared digital content) of the contextual boundaries as well as the sequence or order in which such portions are to be recorded. For example, the user may define a workflow sequence with the order of first recording a slide from the shared digital presentation followed by recording the slide from the digital presentation along with the avatar of the presenter followed by recording a view of the entire collaborative environment (digital or virtual reality environment of the metaverse that consists of avatars and shared digital content) which includes the slide from the digital presentation, etc. In another example, the user may define a workflow sequence with the order of first recording the first 5 minutes of the slides from the shared digital presentation followed by recording the slide from the digital presentation along with the avatar of the presenter for the next 20 seconds followed by recording the next 5 minutes of the slides from the shared digital presentation.

In operation 709, recording mechanism 401 of metaverse collaboration content recording mechanism 108 receives the contextual boundaries from the user (e.g., user of computing device 101, user 104) to perform selective recording in a collaborative environment of the metaverse.

In operation 710, recording mechanism 401 of metaverse collaboration content recording mechanism 108 receives the workflow sequence from the user (e.g., user of computing device 101, user 104) which defines the portions of the contextual boundaries to record via one or more nodes.

In operation 711, recording mechanism 401 of metaverse collaboration content recording mechanism 108 records the metaverse collaboration content in the collaborative environment using a recording node sequence (discussed below in connection with FIG. 8) based on the workflow sequence.

As discussed above, in one embodiment, after receiving the workflow sequence from the user, recording mechanism 401 selectively records metaverse collaboration content in the collaborative environment based on such a workflow sequence. In one embodiment, such a recording is accomplished by merging different portions of the contextual boundaries via nodes. “Nodes,” as used herein, are computing devices that are responsible for generating different portions of the collaborative environment, such as the avatar of the presenter, the shared digital presentation, the avatars of the students, street views, cars, etc. In one embodiment, a recording node sequence is generated to assist in the recording of the metaverse collaboration content in the collaborative environment as discussed below in connection with FIG. 8.

FIG. 8 is a flowchart of a method 800 for generating the recording node sequence in accordance with an embodiment of the present disclosure.

Referring to FIG. 8, in conjunction with FIGS. 1-7, in operation 801, node sequence engine 402 of metaverse collaboration content recording mechanism 108 generates a knowledge corpus (e.g., knowledge corpus 310) based on profile contextual boundaries 309, templates 307 and contextual information 308.

As discussed above, “knowledge corpus,” such as knowledge corpus 310, as used herein, refers to a collection or body of knowledge directed to collaborative environments of the metaverse. “Profile contextual boundaries 309,” just as the contextual boundaries provided by users (e.g., users of computing devices 101), refer to the designations, descriptions or labels in the collaborative environment, such as the participants and collaboration content being shared in the collaborative environment, based on the context (interrelated conditions) of the collaborative environment. In one embodiment, such profile contextual boundaries 309 that are used to generate the knowledge corpus (e.g., knowledge corpus 310) are provided by an expert, such as the developer of the collaborative environment. Furthermore, as discussed above, a “template 307,” as used herein, refers to a file that indicates the overall layout of one or more portions (e.g., avatar of the presenter with the shared digital presentation) of the collaborative environment. In one embodiment, such a template may be created by an expert, such as the developer of the collaborative environment. “Contextual information 308,” as used herein, refers to the information about the structure, content and context of one or more portions (e.g., avatar of the presenter with the shared digital presentation) of the collaborative environment. In one embodiment, such contextual information may be created by an expert, such as the developer of the collaborative environment.

In operation 802, node sequence engine 402 of metaverse collaboration content recording mechanism 108 receives the workflow sequence discussed above.

As stated above, the “workflow sequence” refers to the order of the selective recording in the collaborative environment of the metaverse. In particular, the workflow sequence defines the portions (e.g., views of the collaborative environment, particular slides of the shared digital content) of the contextual boundaries as well as the sequence or order in which such portions are to be recorded.

In operation 803, node sequence engine 402 of metaverse collaboration content recording mechanism 108 generates the recording node sequence to record the metaverse collaboration content in the collaborative environment based on the knowledge corpus and the workflow sequence.

As discussed above, in one embodiment, node sequence engine 402 is configured to map the order in which such portions of the contextual boundaries are to be recorded to the nodes utilized for generating such portions of the collaborative environment, such as the avatar of the presenter, the shared digital presentation, the avatars of the students, street views, cars, etc. In one embodiment, such mapping may be obtained via the use of a data structure (e.g., table) that contains a listing of the nodes and the associated portions of the collaborative environment that such nodes are responsible for generating the content (e.g., avatars, digital presentation, street views, etc.) in such portions of the collaborative environment. In one embodiment, such a data structure is populated by an expert. In one embodiment, such a data structure resides within the storage device (e.g., storage device 611, 615) of metaverse collaboration content recording mechanism 108. Hence, based on the sequence or order in which such portions are to be recorded, node sequence engine 402 determines the sequence of nodes (“recording node sequence”) to generate such portions of the collaborative environment based on such a data structure.

Furthermore, in one embodiment, such a node sequence (“recording node sequence”) used to record the metaverse collaboration content in the collaborative environment is based on the knowledge corpus (e.g., knowledge corpus 310), which may be used to predict and recommend recording node sequences. For example, profile contextual boundaries 309, templates 307 and contextual information 308 of the knowledge corpus, such as knowledge corpus 310, provides details as to the portions of the collaborative environment, the layout of such portions as well as the structure, content and context of such portions. Based on the workflow sequence, which defines the order of the portions of the collaborative environment to be recorded, the details about such portions of the collaborative environment, the layout of such portions as well as the structure, content and context of such portions can be obtained from the knowledge corpus, such as knowledge corpus 310. Nodes that are utilized to generate such details, layouts, structure, content and context may then be identified by node sequence engine 402 via a data structure (e.g., table) which maps such nodes to such details, layouts, structure, content and context. In one embodiment, such a data structure is populated by an expert. In one embodiment, such a data structure resides within the storage device (e.g., storage device 611, 615) of metaverse collaboration content recording mechanism 108. Hence, based on the knowledge corpus, such as knowledge corpus 310, and workflow sequence, node sequence engine 402 determines the sequence of nodes (“recording node sequence”) to generate such portions of the collaborative environment in the order specified by the workflow sequence based on such a data structure.

Returning to operation 711 of FIG. 7, in conjunction with FIGS. 1-6 and 8, in one embodiment, recording mechanism 401 utilizes such a recording node sequence to record the metaverse collaboration content in the collaborative environment based on the workflow sequence. In one embodiment, recording mechanism 401 utilizes a software tool, such as VRCLens, which is a set of photographic extensions to the stock VRChat® camera that could be placed in an avatar. In one embodiment, such a tool includes zooming, depth of field simulation, image stabilization, avatar-detect autofocus (only focus on the avatar and ignore the scenery), etc.

In one embodiment, such recording of the selective portions of the contextual boundaries as defined by the workflow sequence is performed asynchronously or linearly by recording mechanism 401.

In one embodiment, such recorded content (recorded metaverse collaboration content) is stored in database 109.

In connection with such a recording, the recorded content may include mobility content discussed below.

In operation 712, tracking engine 403 of metaverse collaboration content recording mechanism 108 tracks the mobility of the content in the workflow sequence, where the tracked content is recorded by recording mechanism 401 of metaverse collaboration content recording mechanism 108.

As discussed above, in one embodiment, the mobility of the content in the workflow sequence (e.g., movement of the avatar in the collaborative environment) is tracked by tracking engine 403. In one embodiment, tracking engine 403 utilizes a software tool, such as VRCLens, for tracking the movement or mobility of the content in the workflow sequence. Other software tools for tracking the movement or mobility of the content in the workflow sequence include, but not limited to, WEbXR, Blender™, Xsens®, etc.

In one embodiment, recording mechanism 401 utilizes a software tool, such as VRCLens, to record the tracked mobile content (e.g., movement of the avatar in the collaborative environment).

In one embodiment, the recording performed by recording mechanism 401 is terminated upon the termination of the session or when the recording is autonomously marked completed, such as by the user (e.g., user of computing device 101, user 104). In one embodiment, the termination of the recoding is indicated by the workflow session, which identifies an event, time or action upon which recording of the collaboration content is to be terminated.

In operation 713, collaborative environment creator 404 of metaverse collaboration content recording mechanism 108 creates a second collaborative environment of the metaverse (e.g., collaborative environment 502) based on the recorded metaverse collaboration content.

As discussed above, in one embodiment, collaborative environment creator 404 creates such collaborative environments, such as the second collaborative environment of the metaverse (e.g., collaborative environment 502), based on the recorded metaverse collaboration content using various software tools, including, but not limited to, Gather®, Decentraland®, AltspaceVR®, Magic Leap®, Wonder, etc.

In one embodiment, collaborative environment creator 404 creates such collaborative environments, such as the second collaborative environment of the metaverse (e.g., collaborative environment 502), by designing the metaspace (conceptual space occupied by virtual objects of the metaverse) of the collaborative environment based on the recorded metaverse collaboration content (e.g., avatars, digital presentation content, virtual meeting room, etc.). In one embodiment, after designing the metaspace of the collaborative environment, collaborative environment creator 404 builds an interaction layer in order for users to interact with others in the collaborative environment. In one embodiment, such an interaction layer includes user controls, navigation controls, communication protocols, access criteria, etc. In one embodiment, the design of the metaspace and building of the interaction layer is accomplished by collaborative environment creator 404 using various software tools, including, but not limited to, Gather®, Decentraland®, AltspaceVR®, Magic Leap®, Wonder, etc.

Furthermore, as discussed above, in one embodiment, the second collaborative environment of the metaverse (e.g., collaborative environment 502) is created based on the portions of the contextual boundaries defined by the workflow sequence to be recorded via one or more nodes as shown in FIG. 5.

Referring to FIG. 5, FIG. 5 illustrates a first collaborative environment 501, where recording mechanism 401 selectively records metaverse collaboration content in the collaborative environment, such as the first collaborative environment 501, using a recording node sequence based on the workflow sequence. Furthermore, such recording includes recording the tracked mobile content (e.g., movement of the avatar in the collaborative environment).

As further shown in FIG. 5, collaborative environment creator 404 creates a second collaborative environment 502 comprised of selective portions of the metaverse collaboration content in the first collaborative environment 501 that was recorded by recording mechanism 401. As stated above, a “collaborative environment,” as used herein, refers to the digital or virtual reality environment of the metaverse that consists of avatars and shared digital content. For example, such selective portions 503A-503C (identified as “Selective Portion 1,” “Selective Portion 2,” and “Selective Portion 3,” respectively) are utilized to create the second collaborative environment 502. For instance, selective portion 503A is directed to the shared digital presentation content, selective portion 503B is directed to the presenter along with the shared digital presentation content and selective portion 503C is directed to the audience (students) along with the presenter sharing the digital presentation content.

One or more further collaborative environments of the metaverse can be created by collaborative environment creator 404 based on the second collaborative environment 502 as discussed below in connection with FIG. 9.

FIG. 9 is a flowchart of a method 900 for creating a third collaborative environment of the metaverse (e.g., collaborative environment 504) in response to authorized users joining the second collaborative environment of the metaverse (collaborative environment 502) created based on the recorded metaverse collaboration content in accordance with an embodiment of the present disclosure.

In operation 901, collaborative environment creator 404 of metaverse collaboration content recording mechanism 108 determines if requests from one or more authorized users (e.g., users of computing devices 101) have been receive to join the second collaborative environment (i.e., the collaborative environment created in operation 713 of FIG. 7).

If collaborative environment creator 404 does not receive requests from authorized users to join the second collaborative environment, then collaborative environment creator 404 of metaverse collaboration content recording mechanism 108 continues to determine if requests from one or more users (e.g., users of computing devices 101) have been received to join the second collaborative environment (i.e., the collaborative environment created in operation 713 of FIG. 7) in operation 901.

If, however, such requests are received by collaborative environment creator 404, then, in operation 902, collaborative environment creator 404 of metaverse collaboration content recording mechanism 108 creates a third collaborative environment of the metaverse (e.g., a third collaborative environment 504) consisting of a user(s) joining the second collaborative environment of the metaverse (i.e., the collaborative environment created in operation 713 of FIG. 7) via one or more nodes.

As discussed above, in one embodiment, collaborative environment creator 404 determines whether such users requesting to join the newly created collaborative environment, such as second collaborative environment 502, have permission or are authorized to join such a newly created collaborative environment. In one embodiment, collaborative environment creator 404 makes such a determination based on performing a lookup in a data structure (e.g., table), which includes a listing of users who are authorized to join collaborative environments. In one embodiment, such users are listed according to identifiers, such as the user's login identification used to login to metaverse server 102. In one embodiment, such users are designated as being authorized based on a previous payment to enable the user to utilize the service of selectively recording in a collaborative environment of the metaverse. In one embodiment, the data structure is populated by an expert. In one embodiment, the data structure is stored in a storage device (e.g., storage device 611, 615) of metaverse collaboration content recording mechanism 108.

In one embodiment, if the user is deemed to not be authorized to join such a newly created collaborative environment, then, in one embodiment, collaborative environment creator 404 informs the user (e.g., user of user group 505) that the user is not authorized to join the newly created collaborative environment (e.g., collaborative environment 502) via electronic means, such as via an electronic message or an instant message.

If, however, the user is deemed to be authorized to join such a newly created collaborative environment, then, in one embodiment, collaborative environment creator 404 joins the user to the newly created collaborative environment (e.g., collaborative environment 502) via a further created collaborative environment (e.g., collaborative environment 504).

For example, as shown in FIG. 5, a third collaborative environment 504 is created consisting of groups of users 505A-505C (e.g., users of computing devices 101) joining the second collaborative environment 502 of the metaverse via one or more nodes. User groups 505A-505C may consist of a groups of users (identified as “Group A,” “Group B,” and “Group C,” respectively), where multiple users from each of these groups may join the second collaborative environment 502 of the metaverse, including at different selective portions 503, in the created third collaborative environment 504. For example, users from user group 505A may join the second collaborative environment 502 of the metaverse at selective portion 503A. Users from user group 505B may join the second collaborative environment 502 of the metaverse at selective portion 503B. Furthermore, users from user group 505C may join the second collaborative environment 502 of the metaverse at selective portion 503C.

While only a third collaborative environment 504 is shown being created in FIG. 5, collaborative environment creator 404 may create additional collaborative environments, including additional collaborative environments based on the second collaborative environment 502 as discussed above or even based on the third collaborative environment 504 and so forth. Such other collaborative environments are created based on new workflow sequences being received from the user, which are utilized by recording mechanism 401 to record metaverse collaboration content in one of these collaborative environments using a recording node sequence based on such a workflow sequence as discussed above. Such recorded metaverse collaboration content is then used by collaborative environment creator 404 to create a new collaborative environment.

As previously discussed, in one embodiment, collaborative environment creator 404 creates such collaborative environments, such as third collaborative environment 504, using various software tools, including, but not limited to, Gather®, Decentraland®, Altspace VR®, Magic Leap®, Wonder, etc.

In one embodiment, collaborative environment creator 404 creates such collaborative environments, such as third collaborative environment 504, by designing the metaspace (conceptual space occupied by virtual objects of the metaverse) of the collaborative environment based on the recorded metaverse collaboration content (e.g., avatars, digital presentation content, virtual meeting room, etc.). In one embodiment, after designing the metaspace of the collaborative environment, collaborative environment creator 404 builds an interaction layer in order for users to interact with others in the collaborative environment. In one embodiment, such an interaction layer includes user controls, navigation controls, communication protocols, access criteria, etc. In one embodiment, the design of the metaspace and building of the interaction layer is accomplished by collaborative environment creator 404 using various software tools, including, but not limited to, Gather®, Decentraland®, AltspaceVR®, Magic Leap®, Wonder, etc.

As a result of the foregoing, embodiments of the present disclosure provide a means for selectively recording user-designated metaverse collaboration content by utilizing contextual boundaries in the collaborative environment of the metaverse as well as a workflow sequence. “Contextual boundaries,” as used herein, refer to designations in the collaborative environment, including participants and collaboration content being shared in the collaborative environment, based on the context (interrelated conditions) of the collaborative environment. A “workflow sequence,” as used herein, refers to the order of the selective recording in the collaborative environment of the metaverse. In particular, the workflow sequence defines the portions (e.g., views of the collaborative environment, particular slides of the shared digital content) of the contextual boundaries as well as the sequence or order in which such portions are to be recorded. For example, the user may define a workflow with the order of first recording a slide from the shared digital presentation followed by recording the slide from the digital presentation along with the avatar of the presenter followed by recording a view of the entire collaborative environment (digital or virtual reality environment of the metaverse that consists of avatars and shared digital content) which includes the slide from the digital presentation, etc.

Furthermore, the principles of the present disclosure improve the technology or technical field involving the metaverse. As discussed above, the term “metaverse” refers to any digital or virtual reality platform that combines any combination of aspects from online gaming, social media, virtual reality, augmented reality, cryptocurrencies or non-fungible tokens (NFTs) for users to interact with one another. The term “metaverse” originated in the 1992 science fiction novel Snow Crash as a portmanteau of “meta” and “universe.” Metaverse development is often linked to advancing virtual reality technology due to the increasing demands for immersion. Recent interest in metaverse development is influenced by Web3, a concept for a decentralized iteration of the Internet. However, metaverse worlds are not necessarily a uniquely Web3 aspect. For example, the online gaming platform Roblox is considered to be a metaverse world, though it does not use cryptocurrency, NFTs, or blockchain technology on the platform. In contrast, the virtual world Decentraland is an entirely Web3-based platform that utilizes NFTs, cryptocurrencies, decentralized storage and blockchain networks on the backend. An example of a metaverse environment consists of a mixed reality meeting where the users are wearing virtual reality headsets in their virtual offices. After finishing the meeting, a user may relax by playing a blockchain-based game and then managing a crypto portfolio while inside the metaverse. While attending a metaverse collaboration (group of users interacting in the metaverse), a user may want to selectively and autonomously record the metaverse collaboration content. For example, while attending a metaverse collaboration, such as a learning session, where a presenter is sharing digital presentation contents to students, a user may want to selectively record the presentation content, the presentation content along with the presenter (as an avatar) or the entire metaverse collaboration (the avatars of the presenter and students along with the presentation content). Unfortunately, there is not currently a means for enabling a user to selectively record user-designated metaverse collaboration content.

Embodiments of the present disclosure improve such technology by receiving contextual boundaries to perform selective recording in a collaborative environment of a metaverse from a user. A “collaborative environment,” as used herein, refers to the digital or virtual reality environment of the metaverse that consists of avatars and shared digital content. Furthermore, “contextual boundaries,” as used herein, refer to designations in the collaborative environment, including participants and collaboration content being shared in the collaborative environment, based on the context (interrelated conditions) of the collaborative environment. For example, contextual boundaries may include the particular presentation materials being shared, a particular avatar in connection with such presentation materials, etc. In addition to receiving contextual boundaries, a workflow sequence is received from the user. A “workflow sequence,” as used herein, refers to the order of the selective recording in the collaborative environment of the metaverse. In particular, the workflow sequence defines the portions (e.g., views of the collaborative environment, particular slides of the shared digital content) of the contextual boundaries as well as the sequence or order in which such portions are to be recorded. Metaverse collaboration content in the collaborative environment is then recorded using a recording node sequence based on the workflow sequence. In one embodiment, such a recording is accomplished by merging different portions of the contextual boundaries via nodes. “Nodes,” as used herein, are computing devices that are responsible for generating different portions of the collaborative environment, such as the avatar of the presenter, the shared digital presentation, the avatars of the students, street views, cars, etc. In one embodiment, a recording node sequence is generated to assist in the recording of the metaverse collaboration content in the collaborative environment. For example, the recording node sequence of nodes 1, 3 and 5 may be generated, which corresponds to the nodes that generate the content in the sequence indicated in the workflow sequence. A second collaborative environment of the metaverse may then be created based on the recorded metaverse collaboration content. In this manner, user-designated metaverse collaboration content in the metaverse may be selectively recorded. Furthermore, in this manner, there is an improvement in the technical field involving the metaverse.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for selectively recording metaverse collaboration content, the method comprising:
receiving contextual boundaries to perform selective recording in a first collaborative environment of a metaverse;
receiving a workflow sequence which defines portions of said contextual boundaries to record via one or more nodes;
recording metaverse collaboration content in said first collaborative environment of said metaverse using a recording node sequence based on said workflow sequence; and
creating a second collaborative environment of said metaverse based on said recorded metaverse collaboration content.

2. The computer-implemented method as recited in claim 1 further comprising:
tracking mobility of content in said workflow sequence, wherein said tracked mobile content is recorded and made available in said second collaborative environment of said metaverse.

3. The computer-implemented method as recited in claim 1 further comprising:
receiving a request from a user to perform said selective recording in said first collaborative environment of said metaverse; and
determining whether said user has permission to perform said selective recording in said first collaborative environment of said metaverse.

4. The computer-implemented method as recited in claim 3 further comprising:
requesting said user to provide said contextual boundaries and said workflow sequence in response to said user having permission to perform said selective recording in said first collaborative environment of said metaverse.

5. The computer-implemented method as recited in claim 3 further comprising:
requesting said user to provide payment in order to perform said selective recording in said first collaborative environment of said metaverse in response to said user not having permission to perform said selective recording in said first collaborative environment of said metaverse.

6. The computer-implemented method as recited in claim 1 further comprising:
receiving a request from one or more users to join said second collaborative environment of said metaverse; and
creating a third collaborative environment of said metaverse consisting of said one or more users joining said second collaborative environment of said metaverse via one or more nodes.

7. The computer-implemented method as recited in claim 1, wherein said contextual boundaries are defined via hand or finger gestures.

8. A computer program product for selectively recording metaverse collaboration content, the computer program product comprising one or more computer readable storage mediums having program code embodied therewith, the program code comprising programming instructions for:
receiving contextual boundaries to perform selective recording in a first collaborative environment of a metaverse;
receiving a workflow sequence which defines portions of said contextual boundaries to record via one or more nodes;
recording metaverse collaboration content in said first collaborative environment of said metaverse using a recording node sequence based on said workflow sequence; and
creating a second collaborative environment of said metaverse based on said recorded metaverse collaboration content.

9. The computer program product as recited in claim 8, wherein the program code further comprises the programming instructions for:
tracking mobility of content in said workflow sequence, wherein said tracked mobile content is recorded and made available in said second collaborative environment of said metaverse.

10. The computer program product as recited in claim 8, wherein the program code further comprises the programming instructions for:
receiving a request from a user to perform said selective recording in said first collaborative environment of said metaverse; and
determining whether said user has permission to perform said selective recording in said first collaborative environment of said metaverse.

11. The computer program product as recited in claim 10, wherein the program code further comprises the programming instructions for:
requesting said user to provide said contextual boundaries and said workflow sequence in response to said user having permission to perform said selective recording in said first collaborative environment of said metaverse.

12. The computer program product as recited in claim 10, wherein the program code further comprises the programming instructions for:
requesting said user to provide payment in order to perform said selective recording in said first collaborative environment of said metaverse in response to said user not having permission to perform said selective recording in said first collaborative environment of said metaverse.

13. The computer program product as recited in claim 8, wherein the program code further comprises the programming instructions for:
receiving a request from one or more users to join said second collaborative environment of said metaverse; and
creating a third collaborative environment of said metaverse consisting of said one or more users joining said second collaborative environment of said metaverse via one or more nodes.

14. The computer program product as recited in claim 8, wherein said contextual boundaries are defined via hand or finger gestures.

15. A system, comprising:
a memory for storing a computer program for selectively recording metaverse collaboration content; and
a processor connected to the memory, wherein the processor is configured to execute program instructions of the computer program comprising:
receiving contextual boundaries to perform selective recording in a first collaborative environment of a metaverse;
receiving a workflow sequence which defines portions of said contextual boundaries to record via one or more nodes;
recording metaverse collaboration content in said first collaborative environment of said metaverse using a recording node sequence based on said workflow sequence; and
creating a second collaborative environment of said metaverse based on said recorded metaverse collaboration content.

16. The system as recited in claim 15, wherein the program instructions of the computer program further comprise:
tracking mobility of content in said workflow sequence, wherein said tracked mobile content is recorded and made available in said second collaborative environment of said metaverse.

17. The system as recited in claim 15, wherein the program instructions of the computer program further comprise:
receiving a request from a user to perform said selective recording in said first collaborative environment of said metaverse; and
determining whether said user has permission to perform said selective recording in said first collaborative environment of said metaverse.

18. The system as recited in claim 17, wherein the program instructions of the computer program further comprise:
requesting said user to provide said contextual boundaries and said workflow sequence in response to said user having permission to perform said selective recording in said first collaborative environment of said metaverse.

19. The system as recited in claim 17, wherein the program instructions of the computer program further comprise:
requesting said user to provide payment in order to perform said selective recording in said first collaborative environment of said metaverse in response to said user not having permission to perform said selective recording in said first collaborative environment of said metaverse.

20. The system as recited in claim 15, wherein the program instructions of the computer program further comprise:
receiving a request from one or more users to join said second collaborative environment of said metaverse; and
creating a third collaborative environment of said metaverse consisting of said one or more users joining said second collaborative environment of said metaverse via one or more nodes.
